(19) United States
(12) Patent Application Publication
(10) Pub. No.: US 2016/0013677 A1
(43) Pub. Date: Jan. 14, 2016

(54) System and Method for Enabling Automatic Charging Schedules in a Wireless Power Network to One or More Devices

(71) Applicant: Energous Corporation, Pleasanton, CA (US)

(72) Inventors: Douglas Bell, Pleasanton, CA (US); Michael Leabman, San Ramon, CA (US)

(21) Appl. No.: 14/330,931

(22) Filed: Jul. 14, 2014

(51) Int. Cl. H02J 7/02; H02J 17/00; H04W 4/00; H04M 1/725; H04W 84/12; H04W 88/08

(52) U.S. Cl. CPC H02J 7/025; H04W 84/12; H04W 88/08; H04W 4/008; H04M 1/7253; H02J 17/00

(57) ABSTRACT

A system for managing power charging schedules in a wireless power network is disclosed here. The system includes a graphical user interface from which a user may perform scheduling functions in a wireless power network. The disclosed system may store power scheduling records in a database within a wireless power transmitter or other computers in a wireless power network. The wireless power transmitter may use scheduling records in the database to control when to transmit wireless power to a single power receivers or simultaneously to multiple power receivers.

### CROSS-REFERENCE TO RELATED APPLICATIONS

The present disclosure is related to U.S. patent application Ser. No. 13/891,399 entitled Receivers For Wireless Power Transmission, filed May 10, 2013, U.S. patent application Ser. No. 13/891,430 entitled Methodology For Pocket-Forming, filed May 10, 2013, and U.S. patent application Ser. No. 13/891,445 entitled Transmitters For Wireless Power Transmission, filed May 10, 2013, each of which are incorporated by reference in their entirety herein.

### BACKGROUND

1. Field of the Disclosure

The present disclosure relates in general to wireless power transmission, and more specifically to a software system for automatically wirelessly charging one or more client devices, singly or simultaneously, and editing or enabling charging schedules in a wireless power transmission network.

2. Background Information

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall power socket or other power supply to be able to charge his or her electronic device.

An approach to mitigate this issue may include using RF waves through suitable power transmission techniques such as pocket-forming. This approach may provide wireless power transmission while eliminating the use of wires or pads for charging devices. In addition, electronic equipment may require less components as typical wall chargers may not be required. In some cases, even batteries may be eliminated as a device may fully be powered wirelessly.

The approach may enable the creation of wireless power networks similar in structure to regular wireless local area networks (WLAN) where a wireless access point is used to provide internet or intranet access to different devices. An access point or wireless transmitter may provide wireless power charging to different receiver devices.

Electric energy is an important and expensive resource. At times improper handling of electric energy may lead to waste of the valuable resource, in other cases too much electrical current may damage certain devices. It may also be beneficial in some cases to allow power sources to prioritize certain devices over others. In some cases determining which devices to charge and at what times may be tedious. For example, a person may forget to charge their phone thus making the phone run out of battery when most needed. Thus, a need exists for a system for scheduling or prioritizing power transmission in a wireless power network.

### SUMMARY

Disclosed is a system and method for managing a wireless power network and for automatically single or simultaneously wirelessly charge one or more client devices, single or simultaneously, and to enable charging schedules in a wireless power transmission network. The wireless power network may include wireless power transmitters each with an embedded wireless power management application. The power transmitter manager application may include a device database where information about receiver devices, and all other devices in the wireless power network, may be stored.

The wireless power network may include a plurality of client devices with wireless power receivers built in as part of the device or adapted externally. Wireless power receivers may include a power receiver application configured to communicate with the power transmitter manager application in a wireless power transmitter. Communication between wireless power transmitters and wireless power receivers may be achieved using standard network communication protocols such as, Bluetooth, Bluetooth Low Energy, WIFI or the like.

The wireless power network may further include a wireless power application. The wireless power manager may be a software application, which may be hosted in a computing device. The wireless power manager application may communicate with a power transmitter manager application to update information in the wireless power manager's database, such as: statuses, power schedules, setting priorities, authentication credentials, present charge and tracking states, and the like. Wireless power manager may include a GUI which may be used by a user to perform management tasks.

The wireless power manager may include a wireless power schedule software module used to assign priorities and manage automatic charging schedules or manually override charging schedules for different and simultaneous client devices that may receive wireless power in a wireless power network.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission example situation using pocket-forming.

FIG. 2 illustrates a component level embodiment for a transmitter, according to an embodiment.

FIG. 3 illustrates a component level embodiment for a receiver, according to an embodiment.

FIG. 4 illustrates an exemplary embodiment of a wireless power network including a transmitter and wireless receivers.

FIG. 5 is an exemplary embodiment of scheduling records stored in a database.

FIG. 6 is an exemplary embodiment of a wireless power scheduling UI.

FIG. 7 is a flowchart of a process for managing charging schedules or priorities.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

“Scheduling records” may refer to records stored in a database that contain information related to automatic, manual, single, or simultaneous charging schedules and priorities of different power receivers or client devices.

### DESCRIPTION OF THE DRAWINGS

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

Wireless Power Transmission System Including Disclosed Concepts:

Methods disclosed here may be part of a wireless power transmission system including two or more wireless power transmitters, one or more wireless power receivers, one or more optional system management servers, and one or more optional mobile or hand-held computers, smart phones, or the like, that run the system management GUI app. This app may be made available at, downloaded, and installed from a public software app store or digital application distribution platform, such as Apple's iTunes, Google's Play Store, Amazon's Appstore, and the like.

The power transmitters and management servers may all communicate with each other through a distributed system database, and may also communicate present status and any status change to a remote information service that may be located in the Internet cloud.

One or more wireless power transmitters may automatically transmit power to any single wireless power receiver that is close enough for it to establish a communication connection with, using a suitable communication technology, including Bluetooth Low Energy or the like. Said receiver may then power or charge an electrically connected client device, such as mobile device, toy, remote control, lighting device, and the like. A single wireless power transmitter may also power multiple wireless power receivers simultaneously.

Alternately, the system can be configured by the system management GUI to automatically only transmit power to specific wireless power receivers depending on specific system criteria or conditions, such as the time or hour of the day for automatic time-based scheduled power transmission, power receiver physical location, owner of client device, or other any other suitable conditions and/or criteria.

The wireless power receiver is connected electrically to a client device, such a mobile phone, portable light, TV remote control, or any device that would otherwise require a battery or connection to wall power. In one or more embodiments, devices requiring batteries can have traditional batteries replaced by wireless power receiver batteries. The wireless power receiver then receives energy transmitted from the power transmitter, into receiver's antenna, rectifies, conditions, and sends the resulting electrical energy, through an electrical relay switch, to the electrically connected client device to power it or charge it.

A wireless power transmitter can transmit power to a wireless power receiver, which, in response, can power or charge its associated client device while device is in use or in motion anywhere within the power transmission range of the wireless power transmitter. The wireless power transmitter can power multiple devices at the same time.

The wireless power transmitter establishes a real-time communication connection with each receiver for the purpose of receiving feedback in real-time (such as 100 samples per second). This feedback from each receiver includes the measurement of energy presently being received, which is used by the transmitter to control the direction of the transmitter's antenna array so that it stays aimed at the receiver, even if the receiver moves to a different physical 3-D location or is in 3-D motion that changes its physical 3-D location.

Multiple wireless power transmitters can power a given, single receiver, in order to substantially increase power to it.

When a transmitter is done transmitting power to a receiver, it may communicate to the receiver that power transmission has ended, and disconnect communication. The wireless power transmitter may then examine its copy of the distributed system database to determine which, if any, receivers in power range it should next transmit power to.

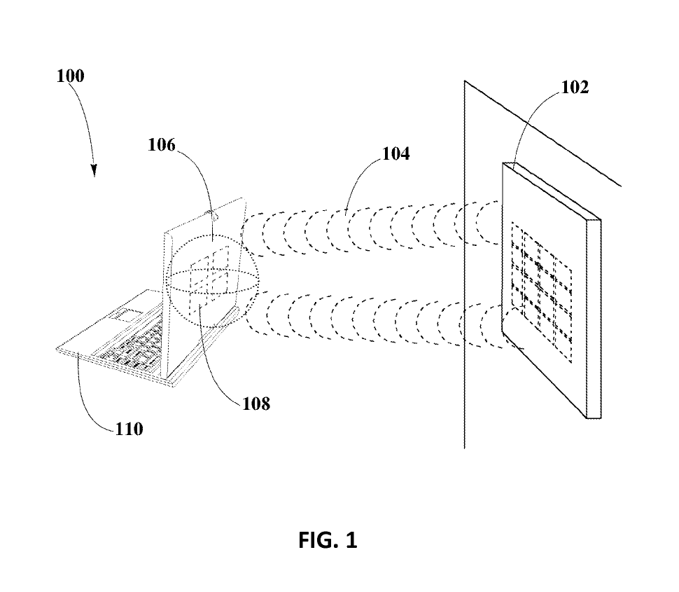

FIG. 1 illustrates wireless power transmission 100 using pocket-forming. A transmitter 102 may transmit controlled Radio Frequency (RF) waves 104 which may converge in 3-d space. These RF waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

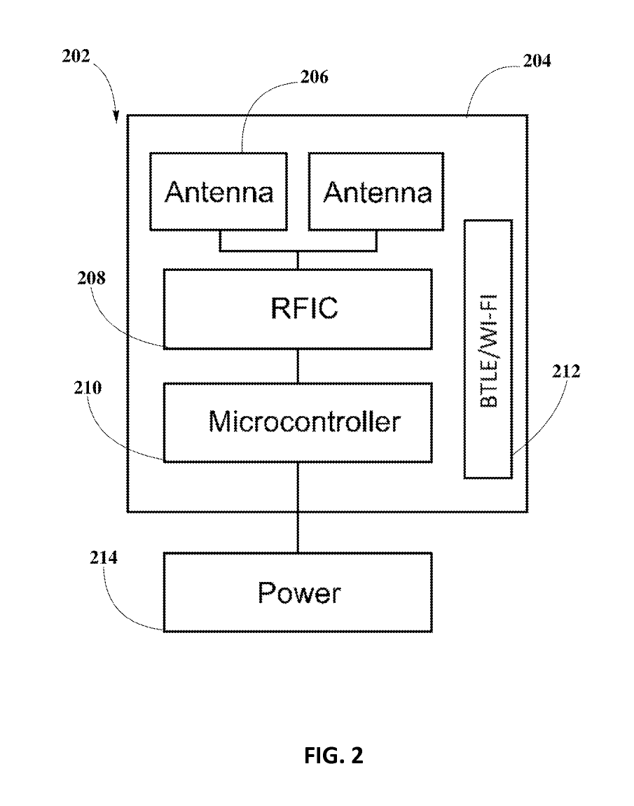

FIG. 2 illustrates a component level embodiment for a transmitter 202 which may be utilized to provide wireless power transmission 100 as described in FIG. 1. Transmitter 202 may include a housing 204 where at least two or more antenna elements 206, at least one RF integrated circuit (RFIC 208), at least one digital signal processor (DSP) or micro-controller 210, and one optional system communications component 212 may be included. Housing 204 can be made of any suitable material which may allow for signal or wave transmission and/or reception, for example plastic or hard rubber. Antenna elements 206 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 206 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Other antenna elements 206 types can be used, for example meta-materials, dipole antennas among others. RFIC 208 may include a proprietary chip for adjusting phases and/or relative magnitudes of RF signals which may serve as inputs for antenna elements 206 for controlling pocket-forming. These RF signals may be produced using an external power supply 214 and a local oscillator chip (not shown) using a suitable piezoelectric material. Micro-controller 210 may then process information received from a power receiver, sent through said receiver's own antenna elements, for determining optimum power, times and locations for pocket-forming. In some embodiments, the foregoing may be achieved through communications component 212. Communications component 212 may be based on standard wireless communication protocols which may include Bluetooth, Bluetooth low energy, Wi-Fi or ZigBee. In addition, communications component 212 may be used to transfer other information such as an identifier for the device or user, battery level, location or other such information. Other communications component 212 may be possible which may include radar, infrared cameras or sound devices for sonic triangulation for determining the device's position.

Multiple transmitter 202 units may be placed together in the same area to deliver more power to individual power receivers or to power more receivers at the same time, said power receivers being within power reception range of all the power transmitters 202.

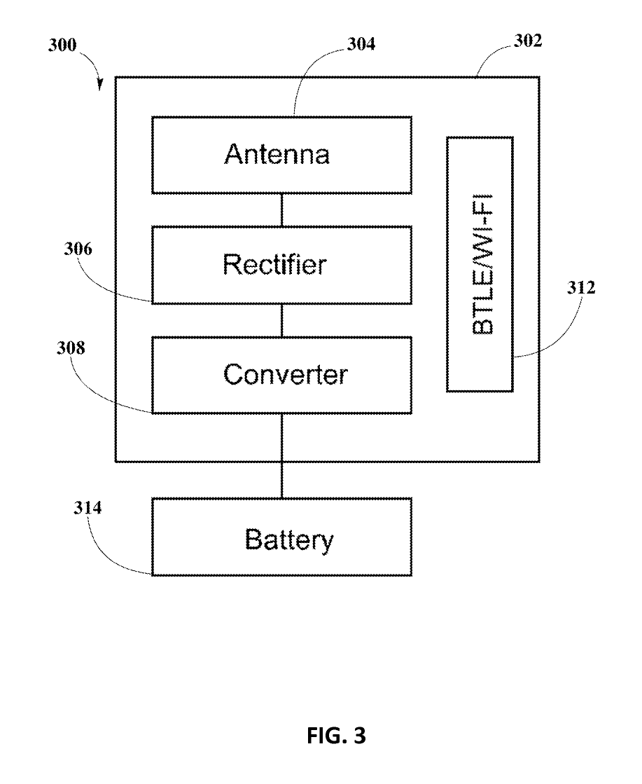

FIG. 3 illustrates a component level embodiment for a receiver 300 which can be used for powering or charging an electronic device as exemplified in wireless power transmission 100. Receiver 300 may include a housing 302 where at least one antenna element 304, one or more rectifiers 306, one power converter 308 and an optional communications component 312 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 202 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 314. Typical voltage outputs can be from about 5 volts to about 10 volts. Lastly, communications component 312, similar to that of transmitter 202 from FIG. 2, may be included in receiver 300 to communicate with a transmitter 202 or to other electronic equipment.

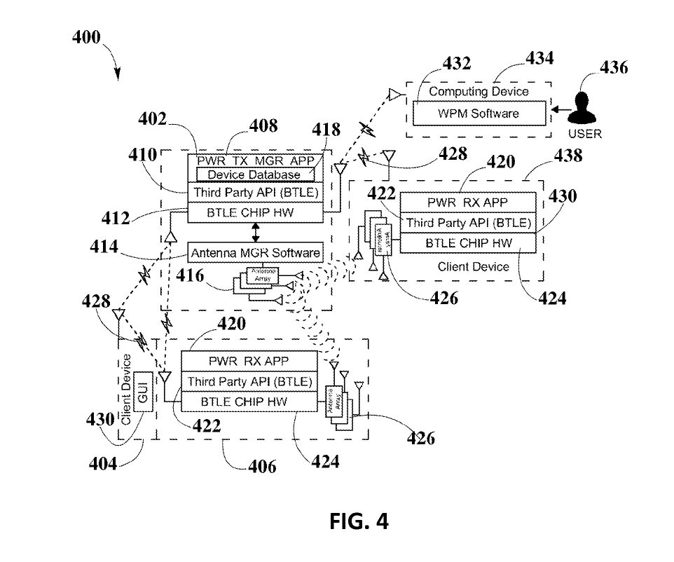

FIG. 4 shows an exemplary embodiment of a wireless power network 400 in which one or more embodiments of the present disclosure may operate. Wireless power network 400 may include communication between wireless power transmitter 402 and one or more wireless powered receivers. Wireless powered receivers may include a client device 404 with an adaptable paired receiver 406 that may enable wireless power transmission to the client device 404. In another embodiment, a client device 438 may include a wireless power receiver 406 built in as part of the hardware of the device. Client device 404 may be any device which uses an energy power source, such as, laptop computers, stationary computers, mobile phones, tablets, mobile gaming devices, televisions, radios and/or any set of appliances that may require or benefit from an electrical power source.

In one embodiment, wireless power transmitter 402 may include a microprocessor that integrates a power transmitter manager app 408 (PWR TX MGR APP) as embedded software, and a third party application programming interface 410 (Third Party API) for a Bluetooth Low Energy chip 412 (BTLE CHIP HW). Bluetooth Low Energy chip 412 may enable communication between wireless power transmitter 402 and other wireless power receivers 406. Wireless power transmitter 402 may also include an antenna manager software 414 (Antenna MGR Software) to control an RF antenna array 416 that may be used to form controlled RF waves which may converge in 3-d space and create pockets of energy on wireless powered receivers. In some embodiment, Bluetooth Low Energy chip 412 may utilize other types of wireless protocol such as WiFi or the like.

Power transmitter manager app 408 may call third party application programming interface 410 for running a plurality of functions such as start a connection, end a connection, and send data among others. Third party application programming interface 410 may command Bluetooth Low Energy chip 412 according to the functions called by power transmitter manager app 408.

Power transmitter manager app 408 may also include a database 418 of all devices in the wireless power network, which may also store relevant information from client devices 404 such as, identifiers for a client device 404, voltage ranges for a client device 404, location, signal strength and/or any relevant information from a client device 404.

Third party application programming interface 410 at the same time may call power transmitter manager app 408 through a callback function which may be registered in the power transmitter manager app 408 at boot time. Third party application programming interface 410 may have a timer callback that may go for ten times a second, and may send callbacks for events, such as but not limited to: every time a connection begins, a connection ends, a connection is attempted, or a message is received.

Power receiver 406 for client device 404 may include a power receiver app 420 (PWR RX APP), a third party application programming interface 422 (Third party API) for a Bluetooth Low Energy chip 424 (BTLE CHIP HW), and a RF antenna array 426 which may be used to receive and utilize the pockets of energy sent from wireless power transmitter 402.

Power receiver app 420 may call third party application programming interface 422 for running a plurality of functions such as start a connection, end the connection, and send data among others. Third party application programming interface 422 may have a timer callback that may go for ten times a second and may send callbacks for events, such as but not limited to: every time a connection begins, a connection ends, a connection is attempted, or a message is received.

Client device 404 may be paired to an adaptable paired receiver 406 via a BTLE connection 428. A graphical user interface (GUI 430) may be used to manage the wireless power network from a client device 404. GUI 430 may be a software module that may be downloaded from any suitable application store and may run on any suitable operating system such as iOS and Android, among others. Client device 404 may also communicate with wireless power transmitter 402 via a BTLE connection 428 to send important data such as an identifier for the device as well as battery level information, antenna voltage, geographic location data, or other real-time information that may be of use for the wireless power transmitter 402.

A wireless power manager 432 software may be used in order to manage wireless power network 400. Wireless power manager 432 may be a software module hosted in memory and executed by a processor inside a computing server device 434. The wireless power manager 432 may include a local application or remote web GUI from where a user 436 may see configuration, logs, options, and statuses, as well as execute commands to manage the wireless power network 400. The computing server device 434 may be connected to the wireless power transmitter 402 through standard communication protocols which may include Bluetooth, Wi-Fi or ZigBee. Power transmitter manager app 408 may exchange information with wireless power manager 432 in order to control access and power transmission from client devices 404 and 438. Functions controlled by the wireless power manager 432 may include, scheduling power transmission for individual devices, priorities between different client devices, access credentials for each client, physical location, broadcasting messages, and/or any functions required to manage the wireless power network 400.

Multiple wireless power transmitter 402 units may be placed together in the same area to deliver more power to individual power receivers or to power multiple receivers at the same time, said power receivers being within power reception range of all the power transmitters 202.

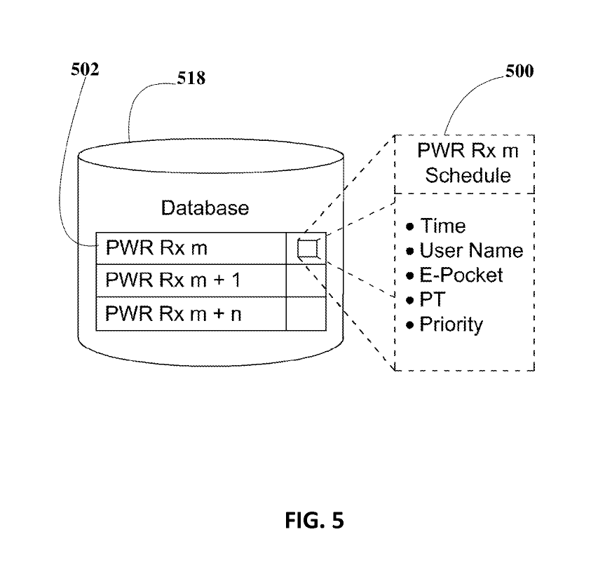

FIG. 5 is an exemplary embodiment of how scheduling records 500 may be stored in the database 518 in a wireless power network. The database 518 may contain a power receiver record 502 for each power receiver found in the wireless power network. Power receiver records 502 may include scheduling records 500 associated with each power receiver record 502, and also a record for every other type of device in the wireless power network, such as power transmitter records, management server records, and client device records, all of which store such information as, but not limited to, status, control, command, and configuration. Power receiver records 502 may include scheduling records 500 associated with each power receiver record 502. Scheduling records may include information such as time, user name, e-pocket, 3d or angular location, power transmitter manager, priority or/and any set of information used for automatic or manually scheduling power transmission to one or more power receiving devices. For example, time may serve to store times of the day at which device may be charged. Priority may serve to indicate the priority of charging the device over other devices, at a specific time. User name may serve to differentiate device users from each other and assign priorities depending on that. E-pocket may serve to store the physical location at which any wireless power receiver shall be immediately charged.

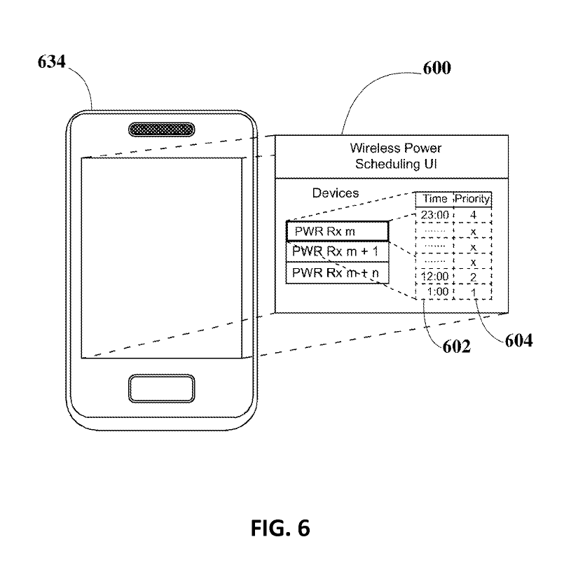

FIG. 6 is an exemplary embodiment of a wireless power scheduling UI 600. Wireless power scheduling UI 600 may be a software module hosted in memory and executed by a processor in a computing device 634. Wireless power scheduling UI 600 may also be included as part of a wireless power manager application in order to manage wireless power schedules in a wireless power network.

Wireless power scheduling UI 600 may query scheduling records from a database in a wireless power transmitter and present them to a user in the display of a computing device 634 such as, a smartphone or laptop, or web page. The user may select a power receiver and set scheduling options for that power receiver or execute any user interface function of the wireless power network using known in the art UI navigation tools such as, a mouse click or touch screen for example or by text message (SMS) or by email or by voice recognition or by motion gesture of handheld device, for example. In the exemplary embodiment the wireless power scheduling UI 600 may allow the user to select time 602 periods and assign a priority level 604 for charging the device during that time period.

In another embodiment, a user may set priorities based on the user of a device. For example the UI may present a user with the user names associated with each power receiver record. The user may then assign different priority levels 604 for each user.

In another embodiment, priorities may be set depending on a place or location. For example the UI may present a user with the pockets of energy (e-pockets) and a user may assign a priority level 604 to the specific pocket of energy which in turn may be a fixed location.

Changes or configurations done by a user in wireless power scheduling UI 600 may then be saved to the database in a wireless power transmitter. The wireless power transmitter may then refer to the scheduling records stored in the database in order to perform any time scheduled power transmission or identify transmission priorities.

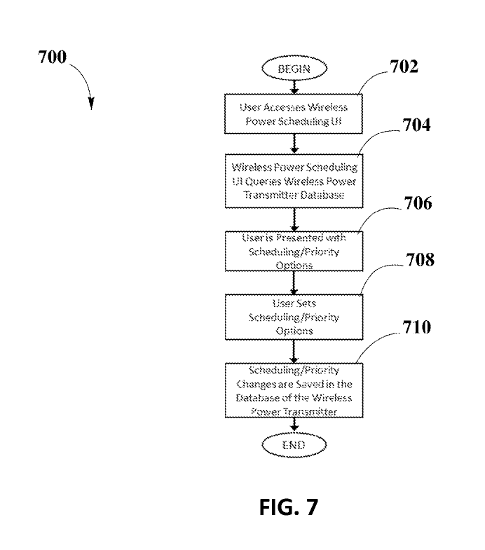

FIG. 7 is a flowchart describing a process 700 by which a user may set up charging schedules or priorities. The process may begin when a user accesses a wireless power scheduling UI (block 702). The wireless power scheduling UI may be a software module hosted in memory and executed by a processor in a suitable computing device, such as, a laptop computer, smartphone and the like. The wireless power scheduling software may then query (block 704) a database stored in a wireless power transmitter in order to extract scheduling records and priorities for all wireless power receivers in the wireless power network. The extracted information may then be presented (block 706) to the user in a wireless power scheduling UI such as the one described in FIG. 6. The user may then manage schedules and priorities (block 708) for all the devices through the wireless power scheduling UI using any navigation tools provided by the computing device such as, for example, touchscreens, keyboards and mouse. Schedules and priorities set or changed by the user may then be saved to the database stored in a wireless power transmitter (block 710).

A wireless power transmitter may continually query scheduling records and perform actions accordingly to automatically control the present state of charging for one or more power receivers.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. An apparatus for controlling wireless power delivery, comprising:
a transmitter comprising two or more antenna elements;
a radio-frequency (RF) circuit, operatively coupled to the transmitter;
a processor, operatively coupled to the RF circuit, wherein the processor is configured to generate pocket-forming energy in three-dimensional space to one or more receivers via the transmitter and RF circuit; and
a storage, operatively coupled to the processor, the storage being configured to store receiver data for each of the one or more receivers, wherein the processor is configured to process the receiver data to control the generation of pocket-forming energy.

2. The apparatus of claim 1, wherein the receiver data comprises schedule data.

3. The apparatus of claim 2, wherein the schedule data comprises one or more of time data, receiver user name data, energy pocket data, 3-dimensional data, angular location data, and receiver priority data.

4. The apparatus of claim 1, wherein the processor is configured to receive and process modified receiver data to perform a modified control of generation of pocket-forming energy.

5. The apparatus of claim 1, wherein the receiver data comprises feedback data comprising a measurement of pocket-forming energy being received at each receiver.

6. The apparatus of claim 5, wherein the processor is configured to perform a modified control of generation of pocket-forming energy based on the feedback data.

7. The apparatus of claim 1, wherein the storage is configured to store transmitter data for one or more other apparatuses providing wireless power delivery.

8. A method for controlling wireless power delivery, comprising:
generating pocket-forming energy in three-dimensional space, via a transmitter comprising two or more antenna elements, for transmission to one or more receivers;
receiving receiver data for each of the one or more receivers;
processing the receiver data; and
controlling the generation of pocket-forming energy based on the processed receiver data

9. The method of claim 8, wherein the receiver data comprises schedule data.

10. The method of claim 9, wherein the schedule data comprises one or more of time data, receiver user name data, energy pocket data, 3-dimensional data, angular location data, and receiver priority data.

11. The method of claim 8, further comprising the step of receiving and processing modified receiver data to perform a modified control of the generation of pocket-forming energy.

12. The method of claim 8, wherein the receiver data comprises feedback data comprising a measurement of pocket-forming energy being received at each receiver.

13. The method of claim 12, further comprising the step of performing a modified control of generation of pocket-forming energy based on the feedback data.

14. The method of claim 8, further comprising the step of storing transmitter data for one or more other apparatuses providing wireless power delivery.

15. A method for controlling wireless power delivery, comprising:
generating pocket-forming energy in three-dimensional space, via a processor-controlled radio-frequency (RF) circuit operatively coupled to a transmitter comprising two or more antenna elements;
receiving receiver data for each of the one or more receivers;
processing the receiver data; and
controlling at least one of a time, direction and power of generation of pocket-forming energy based on the processed receiver data.

16. The method of claim 15, wherein the receiver data comprises schedule data.

17. The method of claim 16, wherein the schedule data comprises one or more of time data, receiver user name data, energy pocket data, 3-dimensional data, angular location data, and receiver priority data.

18. The method of claim 15, further comprising the step of receiving and processing modified receiver data to perform a modified control of at least one of the time, direction and power of the generation of pocket-forming energy.

19. The method of claim 15, wherein the receiver data comprises feedback data comprising a measurement of pocket-forming energy being received at each receiver.

20. The method of claim 19, further comprising the step of performing a modified control of at least one of the time, direction and power of generation of pocket-forming energy based on the feedback data.
